(19) United States
(12) Patent Application Publication
(10) Pub. No.: US 2006/0278733 A1
(43) Pub. Date: Dec. 14, 2006

(54) Water-spraying positioning device of a windshield

(76) Inventor: Chi-Cheng Chang, Taichung City (TW)

Correspondence Address: CHI-CHENG CHANG, 235 Chung-Ho Box 8-24, Taipei, TW

(21) Appl. No.: 11/501,086

(22) Filed: Aug. 9, 2006

(30) Foreign Application Priority Data
Aug. 11, 2004 (TW) 94213751

(51) Int. Cl. B05B 1/10; B60S 1/46

(52) U.S. Cl. 239/284.1; 239/284.2

(57) ABSTRACT

A water-spraying positioning device of a windshield comprises a sleeve; a rear inner wall of the sleeve being threaded; a front end of the sleeve having a light transmitting hole; a laser indicator being installed within the sleeve; a front end of the laser indicator being installed with a light projection seat; laser beams from the light projection seat transmitting through the light transmitting hole; and the thread of the sleeve being screwed with an adjusting rod; an outer thread of the adjusting rod serving to screw to the rear end of the sleeve; a center portion at an rear end surface of the adjusting rod being axially protruded with an ejecting rod; and a center portion of the rear end surface of the ejecting rod being axially protruded with an axial rod; and the axial rod being coaxial with the laser beam.

### FIELD OF THE INVENTION

The present invention relates to windshields, in particular to a water-spraying positioning device of a windshield, wherein the angle of the sprayer in front of the windshield can be adjusted rapidly so that water spraying from the sprayer can be adjusted to a desired position.

### BACKGROUND OF THE INVENTION

In current water-spraying positioning device of a windshield, a telescopic slender tube is inserted into a water spraying hole of a car sprayer. The hole is communicated to a front end of a rotatable ball valve of the sprayer for adjusting the water spraying angle of the sprayer and thus the water beam can be adjusted to a desired position in the windshield. However in this prior art, a plurality of hollow metal tubes are coaxially connected. A thicker end of the telescopic tube is protruded with an ejecting slender rod matching the water spraying hole of the sprayer. In use, the ejecting slender rod must be inserted into the hole for adjusting the water spraying angle. A slender end of the telescopic tube is pulled out to be in front of the windshield. When the ejecting slender rod swings to adjust the angle of the hole, the slender end of the telescopic tube also swings to a desired adjusted position. However this prior art telescopic tube is heavy and is not difficult to be operated. Furthermore, in use, the telescopic tube must be pulled out. This causes a trouble in operation. Thereby this prior art is not practical.

### SUMMARY OF THE INVENTION

Accordingly, the primary object of the present invention is to provide a water-spraying positioning device of a windshield, wherein the angle of the sprayer in front of the windshield can be adjusted rapidly so that water spraying from the sprayer can be adjusted to a desired position.

To achieve above objects, the present invention provides a water-spraying positioning device of a windshield which comprises a sleeve which is a hollow cylinder; a rear inner wall of the sleeve being threaded; a front end of the sleeve having a light transmitting hole; a laser indicator being installed within the sleeve; the laser indicator having a trigger circuit with a laser module for actuating a laser beam; a front end of the laser indicator being installed with a light projection seat; laser beams from the light projection seat transmitting through the light transmitting hole of the sleeve; and an adjusting rod enclosed by a protection cover; the thread at the rear inner wall of the sleeve being screwed with the adjusting rod; an outer thread of the adjusting rod serving to screw to the rear end of the sleeve; a center portion at an rear end surface of the adjusting rod being axially protruded with an ejecting rod; and a center portion of the rear end surface of the ejecting rod being coaxially protruded with an axial rod; and the axial rod being coaxial with the laser beam.

The various objects and advantages of the present invention will be more readily understood from the following detailed description when read in conjunction with the appended drawing.

### BRIEF DESCRIPTION OF THE DRAWINGS

FIG. 1 is a schematic perspective view of the water-spraying positioning device of a windshield of the present invention.

FIG. 2 is an exploded schematic view of the water-spraying positioning device of a windshield of the present invention.

FIG. 3 is a cross sectional view of the water-spraying positioning device of a windshield of the present invention.

FIG. 4 is a schematic view showing the operation of the water-spraying positioning device of a windshield of the present invention.

FIG. 5 is a schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

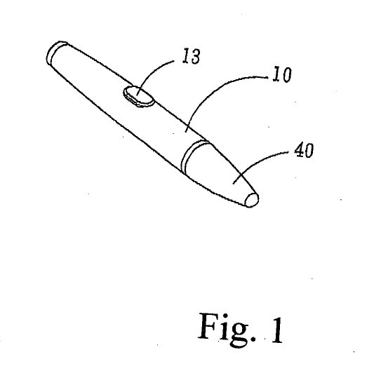

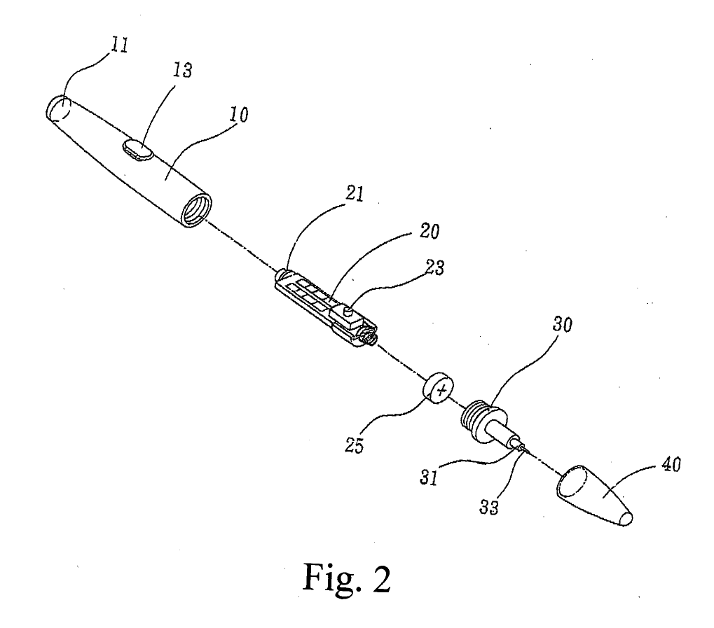

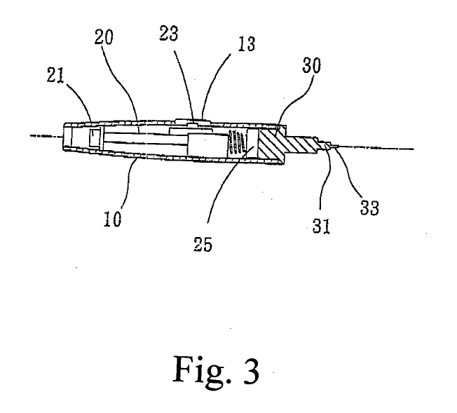

Referring to FIGS. 1 to 3, the structure of the present invention is illustrated. The present invention has the following elements.

A sleeve 10 is a hollow cylinder. A rear inner wall of the sleeve 10 is threaded. A front end of the sleeve 10 has a light transmitting hole 11. A touch button 13 is installed at a lateral side of the sleeve 10.

A laser indicator 20 is installed within the sleeve 10. The laser indicator 20 has a trigger circuit with a laser module for actuating a laser beam. A front end of the laser indicator 20 is installed with a light projection seat 21. The laser beam from the light projection seat 21 transmits through the light transmitting hole 11 of the sleeve 10. A press switch 23 at one side of the laser indicator 20 is installed at a position corresponding to that of the touch button 13 of the sleeve 10. A battery 25 at a lateral side of the laser indicator 20 serves for actuating the power of the laser indicator 20.

An adjusting rod 30 is enclosed by a protection cover 40. The thread at the rear inner wall of the sleeve 10 is screwed with the adjusting rod 30. An outer thread of the adjusting rod 30 serves to screw to the rear end of the sleeve 10. A center portion at a rear end surface of the adjusting rod 30 is axially protruded with an ejecting rod 31. The ejecting rod 31 can be inserted into a water spraying hole of a windshield wiper sprayer 50 for adjusting the direction of the water sprayed. A center portion of the rear end surface of the ejecting rod 31 is axially protruded with an axial rod 33. The axial rod 33 is coaxial with the laser beam so that the laser beam and the spraying water from the sprayer 50 are also coaxial. The sprayer 50 is rotatably installed to a front cover of a car engine.

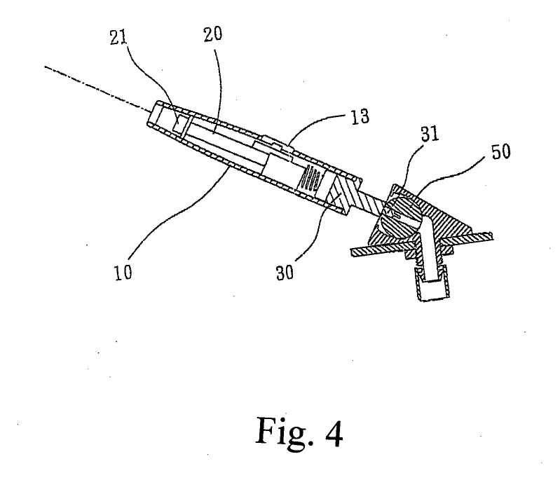

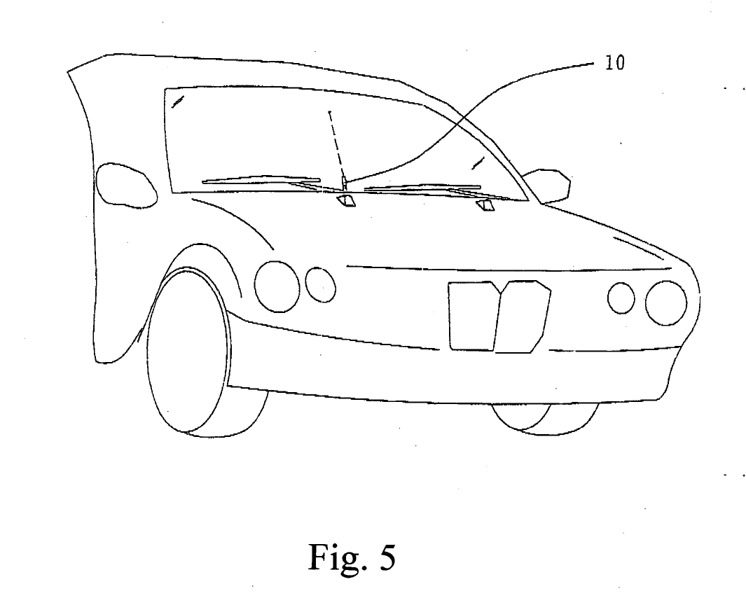

Referring to FIGS. 4 and 5, the use of the present invention is illustrated. The ejecting rod 31 of the adjusting rod 30 is inserted into a water spraying channel of the windshield wiper sprayer 50. By adjusting the positions of the sleeve 10 and the adjusting rod 30, the water spraying orientation of the sprayer 50 can be adjusted synchronously and coaxially. Then the user further presses the touch button 13 for transmitting a laser beam to project upon the windshield. Because the water spraying channel of the sprayer 50, the adjusting rod 30 and the laser indicator 20 are coaxial, by the projection angle of the laser beam, the water spraying orientation of the sprayer 50 in front of the windshield of a car can be adjusted synchronously. Thus, the water-spraying positioning device of a windshield can adjust the water spraying orientation and position of the sprayer rapidly.

Advantages of the present invention will be described below. The water-spraying positioning device of a windshield of the present invention has a compact size and can be operated easily. Thereby the defects of time and labor consumption in the portion design are improved. The water spraying channel of the sprayer 50, the adjusting rod 30 and the laser indicator 20 are coaxial. The technology of laser positioning can be used completely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water-spraying positioning device of a windshield comprising:
a sleeve being a hollow cylinder; a rear inner wall of the sleeve being threaded; a front end of the sleeve having a light transmitting hole;
a laser indicator being installed within the sleeve; the laser indicator having a trigger circuit with a laser module for actuating a laser beam; a front end of the laser indicator being installed with a light projection seat; laser beams from the light projection seat transmitting through the light transmitting hole of the sleeve; and
an adjusting rod enclosed by a protection cover; the thread at the rear inner wall of the sleeve being screwed with the adjusting rod; an outer thread of the adjusting rod serving to screw to the rear end of the sleeve; a center portion at an rear end surface of the adjusting rod being axially protruded with an ejecting rod; and a center portion of the rear end surface of the ejecting rod being axially protruded with an axial rod; and the axial rod being coaxial with the laser beam.

2. The water-spraying positioning device of a windshield as claimed in claim 1, wherein a touch button is installed at a lateral side of the sleeve; a press switch at one side of the laser indicator is installed at a position corresponding to the touch button of the sleeve and a battery at a lateral side of the laser indicator serves for providing power to the laser indicator.

3. The water-spraying positioning device of a windshield as claimed in claim 1, wherein the ejecting rod is inserted into a water spraying hole of a windshield wiper sprayer for adjusting the direction of the water sprayed; the axial rod is coaxial with the laser beam so that the laser beam and the spraying water from the sprayer are also coaxial; and thus the water spraying angle is adjusted.
